(19) United States
(12) Patent Application Publication
(10) Pub. No.: US 2026/0140064 A1
(43) Pub. Date: May 21, 2026

(54) SURFACE INSPECTION USING LASER TRIANGULATION

(71) Applicant: Onto Innovation Inc., Wilmington, MA (US)

(72) Inventors: Jian Ding, Methuen, MA (US); Min Yang, Hillsboro, OR (US)

(21) Appl. No.: 18/954,038

(22) Filed: Nov. 20, 2024

(51) Int. Cl. G01N 21/88; G01N 21/84

(52) U.S. Cl. CPC G01N 21/8851; G01N 2021/8461; G01N 2021/8854; G01N 2201/06113

(57) ABSTRACT

Techniques for inspecting a substrate can include scanning the substrate across a plurality of scan positions using an interrogation beam having a width substantially equal to or greater than a diameter of at least one surface feature on a surface of the substrate to generate scanning results. A set of raw centroid calculation results can be generated based on the scanning results. An error property can be determined and removed from the raw centroid calculation results to generated refined centroid calculation results. A characteristic of the surface feature can be determined based on the centroid calculation results.

### TECHNICAL FIELD

The present disclosure generally relates to inspection and/or metrology techniques. More specifically, the present disclosure relates to image processing techniques to improve accuracy of feature measurements using laser triangulation.

### BACKGROUND

Surface inspection techniques are typically employed to inspect features, such as bumps, formed on substrates. In some conventional systems, a laser used to scan a surface of the substrate under test. The width of the projected laser beam is typically smaller than the diameter of the bumps on the substrate to be inspected. A laser triangulation calculation can then be used to estimate the height of the bump. However, conventional laser triangulation techniques suffer from serious drawbacks, such as low accuracy, when the projected laser width approaches or exceeds the diameter of the bumps on the substrate.

### SUMMARY

Some traditional laser triangulation techniques can assume that the entire interrogating laser beam comes from the same location of the sample examined. These assumptions and approximations are sufficient when, for example, the width of interrogating laser line is relatively smaller than the size of feature, such as a bump, being inspected. However, as the features investigated by the laser line become increasingly small, the width of the interrogating laser beam can be substantially similar to, or larger than, the size of the feature under test, it becomes hard to avoid the situation when part of the laser line is on the feature under test and part of the laser line is off the feature under test.

This disclosure describes an inspection system comprising a light source to scan a substrate across a plurality of scan positions using an interrogation beam having a width substantially equal to or greater than a diameter of at least one surface feature on a surface of the substrate to generate scanning results. The inspection system also comprises at least one processor to generate a set of raw centroid calculation results based on the scanning results; determine an error property in the raw centroid calculation results; remove the error property from the raw centroid calculation results to generate refined centroid calculation results; and determine a characteristic of the at least one surface feature based on the refined centroid calculation results.

This disclosure describes a method for inspecting substrate. The method comprises: scanning the substrate across a plurality of scan positions using an interrogation beam having a width substantially equal to or greater than a diameter of at least one surface feature on a surface of the substrate to generate scanning results; generating a set of raw centroid calculation results based on the scanning results; determining an error property in the raw centroid calculation results; removing the error property from the raw centroid calculation results to generate refined centroid calculation results; and determining a characteristic of the at least one surface feature based on the refined centroid calculation results.

This disclosure describes a machine-storage medium embodying instructions that, when executed by a machine, cause the machine to perform operations comprising: scanning the substrate across a plurality of scan positions using an interrogation beam having a width substantially equal to or greater than a diameter of at least one surface feature on a surface of the substrate to generate scanning results; generating a set of raw centroid calculation results based on the scanning results; determining an error property in the raw centroid calculation results; removing the error property from the raw centroid calculation results to generate refined centroid calculation results; and determining a characteristic of the at least one surface feature based on the refined centroid calculation results.

### BRIEF DESCRIPTION OF THE DRAWINGS

Various ones of the appended drawings merely illustrate example implementations of the present disclosure and should not be considered as limiting its scope.

FIG. 1 illustrates a surface inspection and/or metrology system, according to an example of the present subject matter.

FIG. 2 illustrates a substrate, according to an example of the present subject matter.

FIG. 3A shows the various intersection scenarios of an interrogation beam of a narrow width with a first set of surface features at different instances, according to an example of the present subject matter.

FIG. 3B shows the interaction of an interrogation beam of a wider width with a second set of surface features, according to an example of the present subject matter.

FIG. 4 shows a flow diagram of a method for determining properties of one or more surface features on a substrate, according to an example of the present subject matter.

FIG. 5 shows an example of a set of raw centroid calculations when the beam width is larger than the diameter of the bump, according to an example of the present subject matter.

FIG. 6 shows an example of a best fit line applied to a set of raw centroid calculations, according to an example of the present subject matter.

FIG. 7 shows an example of a refined set of centroid calculations, according to an example of the present subject matter.

FIG. 8A shows a bump with a substantially flat dome-like top, according to an example of the present subject matter.

FIG. 8B shows a bump with a tilted or slanted top, according to an example of the present subject matter.

FIG. 9A shows a plot of mean slope calculations, according to an example of the present subject matter.

FIG. 9B shows the conversion of average slope calculations to tilt angle distribution, according to an example of the present subject matter.

FIG. 10 illustrates a block diagram of an example comprising a machine upon which any one or more of the techniques (e.g., methodologies) discussed herein may be performed.

### DETAILED DESCRIPTION

In surface inspection systems utilizing laser triangulation, as surface features to be measured become ever smaller, the laser spot size or laser line width can be minimized to improve spatial resolution. However, the reduced size of the interrogating laser line also slows down the measurement procedure. Smaller spot sizes or narrower line widths also increase the number of points to be analyzed, which slows the measurement speed of the surface inspection system.

In contrast, the surface inspection techniques of the present disclosure can be configured to utilize a laser spot size or a laser line width that is substantially the same or larger in size to that of a dimension of a measurable aspect of at least one surface feature to be analyzed (for example, a diameter, a height, a circumference, and the like). The larger laser spot size or line width can be configured to cover a larger area of the surface under test at a time, which can increase scanning speed over the surface under test and enhance system measurement throughput. Image processing techniques, as described herein, can correct for errors introduced by the wider laser beam. For example, a best line fit algorithm can be applied to scan data to determine an error property introduced by using a wider laser beam. The error property can then be subtracted from the scan results to generate refined results that can then be used to determine characteristics, such as a height, of the features under inspection using centroid calculation and laser triangulation techniques. Moreover, the error properties can be further analyzed and be used to determine other characteristics of the features under inspection, such as a tilt in the features under inspection.

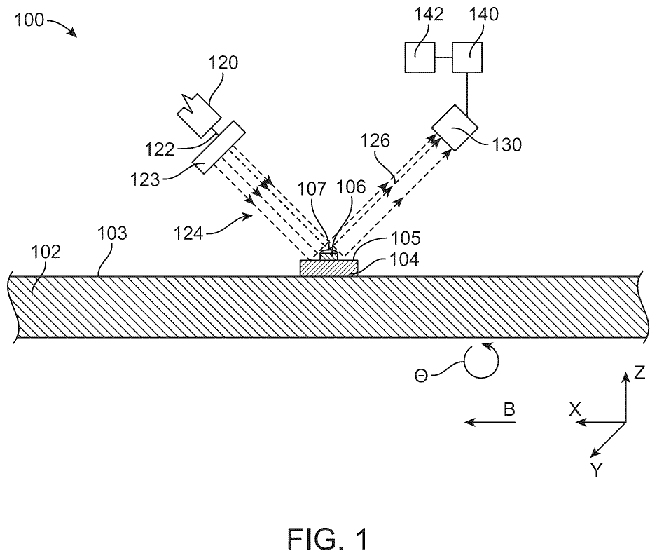

Various types of substrates, such as semiconductor wafers, are typically placed into various types of production tools for processing within a fabrication facility (e.g., such as an integrated circuit manufacturing-facility). A robot is used to place the substrates onto a substrate stage within the tool, to prepare the substrate for processing within a processing chamber. FIG. 1 illustrates a schematic diagram of a surface inspection and/or metrology system 100. The system 100 includes a moveable stage 102 with a carrier surface 103 to carry a substrate 104 processable to form a semiconductor device. The stage 102 can be configured to move the substrate 104 in, for example, an x-direction, a y-direction, a z-direction, and a θ-direction (rotating the substrate 104 within the x-y plane as indicated by the arrow surrounding the stage 102). In the example of FIG. 1, the substrate 104 moves along the x-direction as indicated by the arrow B. In some examples, the x, y, z, or theta stages may carry the detection or part of the detection apparatus, as described below, instead of the sample under test.

In some examples, which are not intended to be limiting, the substrate 104 can include a wafer including elemental semiconductors (e.g., silicon or germanium), a wafer including compound semiconductors (e.g., gallium arsenide (GaAs) or gallium nitride (GaN)), or variety of other substrate types known in the art (including conductive, semiconductive, and non-conductive substrates, such as glass).

The substrate 104 includes a surface under test 105. The surface under test 105 includes at least one surface feature 106. For example, the at least one surface feature 106 may be a bump. In some examples, the surface feature 106 of FIG. 1 includes a solder bump having a substantially cylindrical shape with an arcuate, dome-like or flat top 107. The at least one surface feature 106 may project upward along the z-direction from a plane of the surface under test 105 as shown in FIG. 1, or may extend downward along the z-direction to form a recess into the surface under test 105. The at least one surface feature 106 on the substrate 104 of the surface under test 105, which may have the same or different shapes, may have any size and shape.

The system 100 further includes a light source 120, such as, for example, one or more lasers, which emits an interrogating beam 122. Suitable lasers include, but are not limited to, continuous wave (CW) diode pumped lasers. The interrogating beam 122 formed by the one or multiple lasers is shaped and sized by an optical train 123 to form a laser line 124, which can be a variable width. In this case, the laser line direction is along the y-direction. The width of the laser line 124 may be selected using the lens system in the optical train 123.

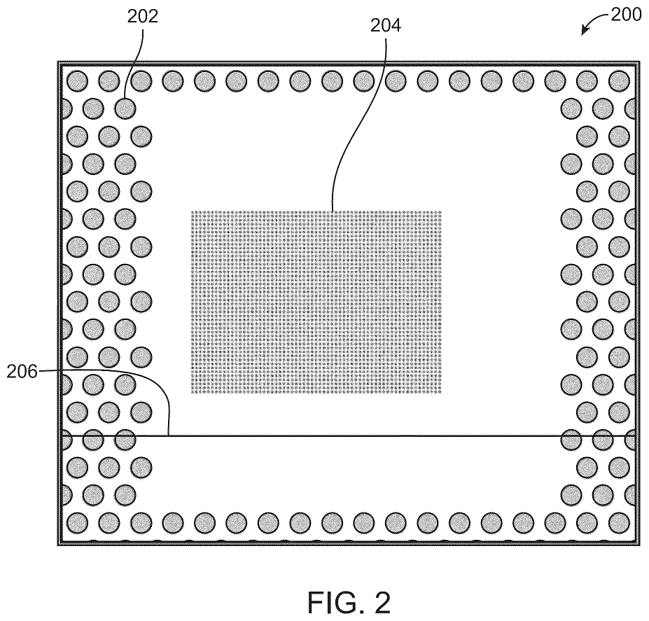

As the stage 102 moves along the x-direction in the example of FIG. 1, the surface under test 105 and the surface feature 106 interact with the laser line 124. The reflections 126 from the surface under test 105 and the various portions of the surface feature 106 are received by a detector 130. The detector 130 may include one or more collection lenses (e.g., a single variable focal-length lens or a plurality of single focal-length lenses, not shown in FIG. 2) and an image sensor (e.g., a CCD array, a CMOS based sensor, an active-pixel sensor, or other sensor types).

The detector 130 further includes, or is connected to, one or more processors 140 configured to analyze the reflections 126. The processors 140 may be further connected to a user interface 142, which can include displays, input devices, and the like, or to a suitable network.

For example, the detector 130 may include camera boards having related circuitry to facilitate image extraction. In some examples, the detector 130 includes a color camera, e.g., a RGB camera. A color camera may be desirable since captured colors can help differentiate the substrate 104 from the carrier surface 103 of the stage 102. Also, machine-learning frameworks may be trained on color images, which would otherwise cause integration challenges for gray-scale images collected from a monochrome camera. However, with a known substrate type using a network trained using gray-scale images, a monochromatic camera may be used.

As mentioned above, the surface under test of the substrate may include a plurality of surface features. The surface features may be of different sizes. FIG. 2 shows an example of a substrate 200. The substrate 200 includes a first set of surface features 202 and a second set of surface features 204. The first set of surface features 202, in this example, are larger than the second set of surface features 204. For example, the respective diameters of first set of surface features 202 may be between 20-50 microns, and the respective diameters of the second set of surface features may be around 5 microns.

An interrogating beam 206 is also shown in FIG. 2. Here, the width of interrogating beam 206 is greater than the diameters of the respective surface features of the second set of surface features 204. For example, the interrogation beam 206 may be 20 mm long and have an 8 microns narrow focus (i.e., the interrogation beam 206 may be projected as 11.2 microns on the plane of substrate 200 plane with a 45 degree of incident angle) while the respective diameters for the second set of surface features is around 5 microns. The interrogation beam 206 being wider than the surface feature may complicate determining properties, such as surface feature height, as described in further detail below because the interrogation beam 206 can touch different parts of the substrate at the same time. Note that in FIG. 2 the interrogating beam 206 projected on the substrate 200 is enlarged by a geometric factor of 1/cos (angle of incidence).

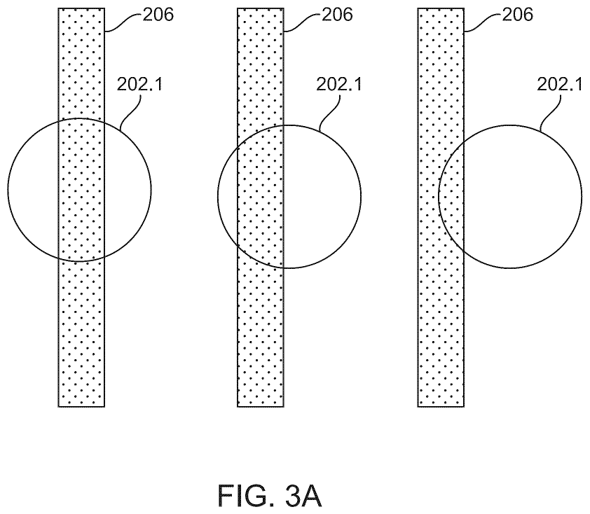

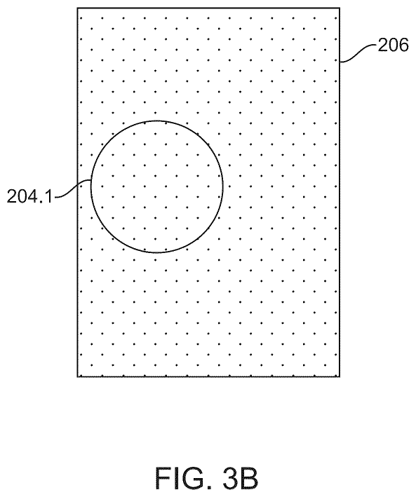

FIG. 3A shows various interaction scenarios of the interrogation beam 206 with surface feature 202.1 of the first set of surface features at different instances. The width of the interrogation beam 206 is narrower than the diameter of surface feature 202.1. Therefore, in most cases, a straight-forward laser triangulation technique can be used to accurately determine properties of the surface feature 202.1, such as height.

FIG. 3B shows the interaction of the interrogation beam 206 with surface feature 204.1 of the second set of surface features. Here, the width of the interrogation beam 206 is wider than the diameter of the surface feature 206.1. Therefore, an error property can be introduced in the laser triangulation technique caused by the width of the interrogation beam 206 being wider than the diameter of the surface feature 206.1.

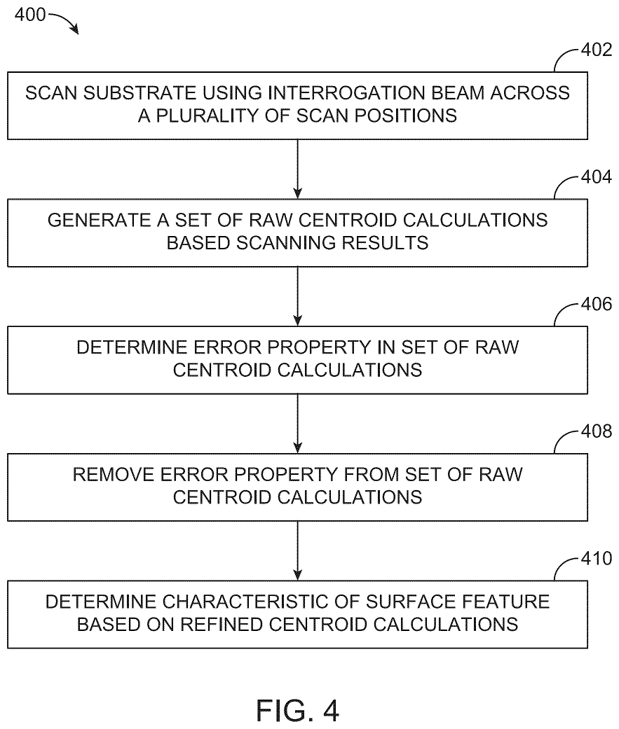

FIG. 4 shows a flow diagram of a method 400 for determining properties of one or more surface features on a substrate. Method 400 may be performed the surface inspection and/or metrology system 100 as described above.

At operation 402, the substrate is scanned across a plurality of scan positions using an interrogation beam. The substrate includes at least one surface feature. In some examples, the substrate may include a plurality of surface features of different diameters. The interrogation beam may have width greater than the diameter of at least one surface feature on the substrate. The scanning may generate a set of scanning results corresponding to the different scan positions. The different scan positions may correspond to the location of the substrate as it moves on the stage. For example, if a scan step size of 1 um is selected, the camera may be triggered by the stage location at every 1 um tick mark to collect an image. As the substrate continues to move, the inspection system may collect an image every 1 um as the substrate moves. Initially, when no part of the interrogation beam is on the surface feature, the reflected beam position is at a first pixel location area on the camera. However, when the system detects a sudden jump in the reflected beam position from the first pixel location area, the system may determine that the interrogation beam is now interacting the surface feature, such as the top of a bump.

At operation 404, a set of raw centroid calculations are generated based on the set of scanning results. A centroid calculation is a technique used to determine the exact position of the interrogation beam (e.g., laser spot) on a detector (e.g., detector 130). The centroid represents the “center of mass” of the intensity distribution of the interrogation beam the on the detector. The position of the laser spot can then be used to for distance measurements using laser triangulation to determine properties of surface features, such as height, as described below in further detail.

Each pixel in the detector may detect a certain amount of light from the interrogation beam, producing an intensity value. The centroid may be calculated using the intensity values (brightness) of the pixels in the detector. The centroid may represent the weighted average of these pixel positions, with brighter pixels contributing more to the position of the centroid.

For example, for a 2D detector, the centroid (xₑ, yₑ) may be determined by:

$${x}_{c} = \frac{\sum ( {x}_{i} \cdot {I}_{i} )}{\sum {I}_{i}}$$

$${y}_{c} = \frac{\sum ( {y}_{i} \cdot {I}_{i} )}{\sum {I}_{i}} ,$$

where xᵢ and yᵢ are the coordinates of each pixel and Ii is the intensity (brightness) value of the pixel at (xᵢ, yᵢ). The sums can be taken over all pixels that detect part of the interrogation beam.

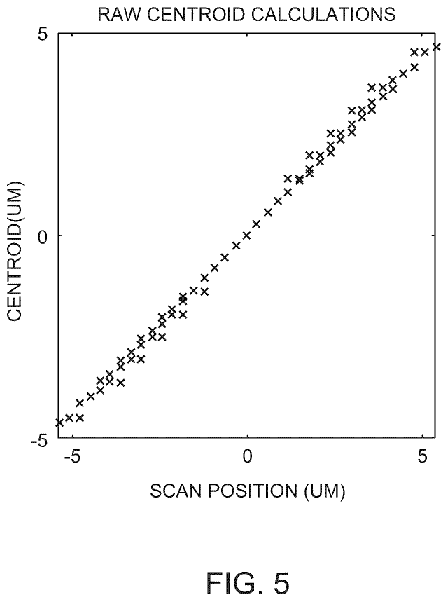

FIG. 5 shows an example of a set of raw centroid calculations. Here, the width of the interrogating beam is wider than the diameter of the at least one surface feature. The x-axis (horizontal axis) shows the scan position (−5 um to 5 um). The y-axis (vertical axis) shows the centroid value based on the intensity values of the respective pixels, as described above. As shown, an error property is present in the set of raw centroid calculations because the centroid values should be around “0.” Instead, the centroid calculations vary from −5 μm to 5 um based on scan position.

Returning to the method 400 of FIG. 4, at operation 406, an error property of the set of raw centroid calculations is determined. For example, the error property may exhibit linear properties. If the relative position between the bump and the interrogating beam is shifted in the scan direction, the raw centroid calculations show a linear relationship between the centroid calculation and scan position. The set of raw centroid calculations may be plotted against scan positions (e.g., FIG. 5). A best line fit algorithm may be applied to determine the linear error property. The linear error property may be represented by the fitted line.

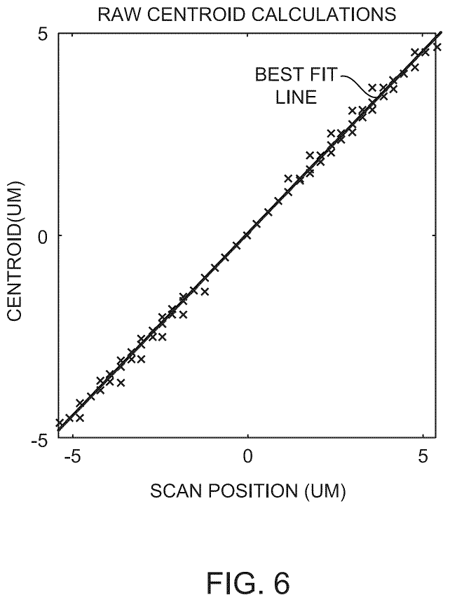

FIG. 6 shows an example of a best fit line applied to the set of raw centroid calculations of FIG. 5. The fitted line represented the linear error property introduced by the width of the interrogation beam being wider than the diameter of the surface feature.

Returning to the method 400 of FIG. 4, at operation 408, the error property is removed from the set of raw centroid calculations to generate a refined set of centroid calculations. For example, the linear error property determined by the best file line algorithm may be subtracted from the set of raw centroid calculations to generate a refined set of centroid calculations.

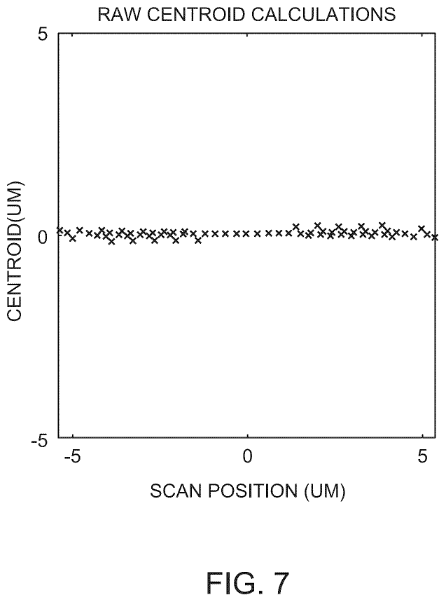

FIG. 7 shows an example of a refined set of centroid calculations based on the initial set of raw centroid calculations of FIG. 5 and the determined linear error property of FIG. 6.

Returning to the method 400 of FIG. 4, at operation 410, a characteristic of the at least one surface feature is determined based on the refined set of centroid calculation. For example, the height of the at least one surface feature (e.g., bump) can be calculated using a laser triangulation technique and the refined set of centroid calculation.

Laser triangulation is a technique used to measure distances or create 3D profiles of surface features using the interrogation beam and detector, as described herein. Laser triangulation is based on the geometric properties of triangles. The interrogation beam is impinged on the substrate and the surface features (e.g., bumps) on the substrate surface. The light from the laser reflects off the surface feature and is detected by the detector, positioned at a known angle relative to the light source (e.g., light sourced 120), such as a laser. The position of the laser spot on the detector changes based on the distance between the detector and the surface feature. The system may then use the known positions of the light source and the detector and the detected position of the interrogation beam using the refined centroid calculation, as described herein, to form a geometric triangle. This laser triangulation technique is particularly useful when the top of the bump is approximately a flat surface. The system may then determine the distance from the detector to the surface feature, which is then used to determine the height of the surface feature. Hence, the position of the interrogation beam on the detector is related to the distance measurement in laser triangulation and accurately calculating the centroid, as described herein, ensures precise distance measurements even when the width of the interrogation beam is greater than the diameter of the surface feature being inspected.

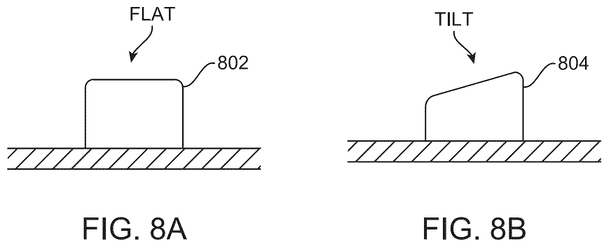

Surface features, such as bumps, may exhibit irregularities in their shapes. FIG. 8A shows a bump 802 with a substantially flat dome-like top. However, manufacturing variations can cause irregularities in the shape of the bumps. Some bumps can exhibit a tilt or slant. FIG. 8B shows a bump 804 with a tilted or slanted top. A tilt angle can be characterized with reference to a horizontal surface of the substrate. In some examples, not all areas on the bump reflect light with the same reflectivity and direction due to these imperfections. These imperfections can affect the slope of the linear behavior between the scan distance and raw centroid calculation.

The error property (slope), described above, may also be used to determine the angle of the tilt or slant on surface features, such as bumps. The slope of the determined linear error property is related to the angle of the tilt or slant. Due to the incident angle of the laser change, the system may determine the slope of the linear error property from the best fit line application of the raw centroid calculations. The system may then determine the angle of the tilt or slant of the surface feature based on the slope of the linear error property.

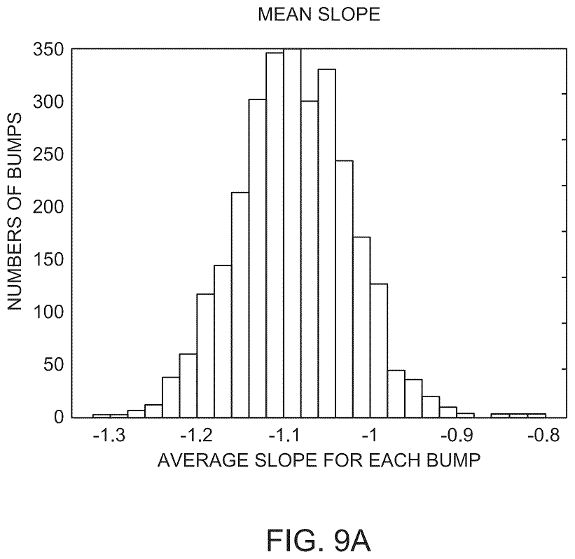

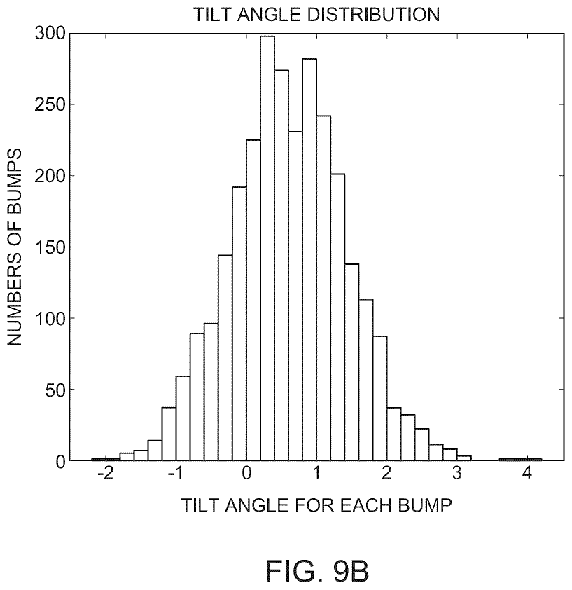

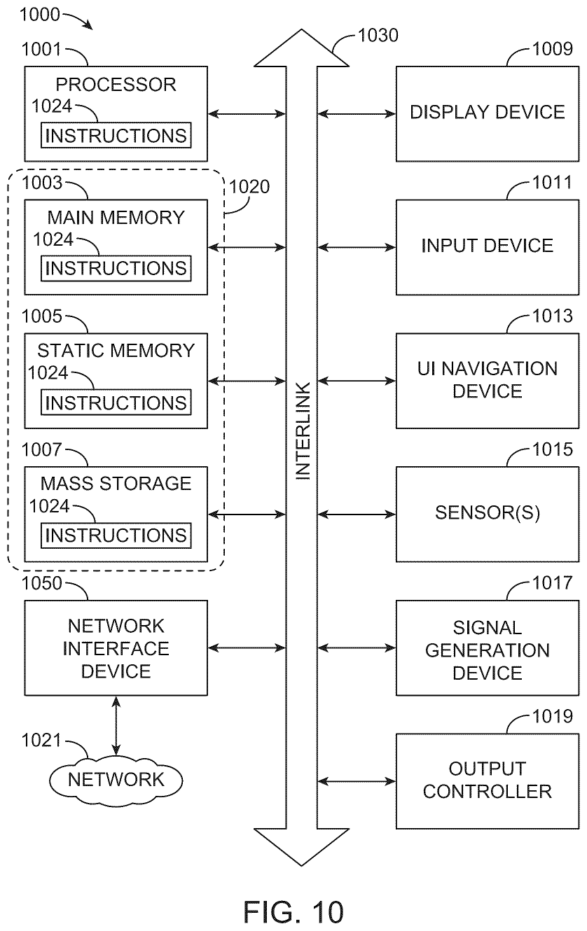

The tilt angle information may be aggregated so that manufacturing techniques can be adjusted accordingly. FIG. 9A shows a plot of mean slope calculations. The x-axis (horizontal axis) shows the average slope for each bump in captured by a detector. The y-axis shows the number of bumps with the corresponding average slopes. FIG. 9B shows the conversion of average slope calculations to tilt angle distribution. The x-axis shows the tilt angle for each bump. The y-axis shows the number of bumps with the corresponding tilt angles. For example, the tilt angle distribution may be used to adjust manufacturing techniques to reduce the tilt angles of the surface features.

The techniques shown and described in this document can be performed using a portion or an entirety of an inspection and/or metrology system as shown in the figures described above or otherwise using a machine 1000 as discussed below in relation to FIG. 10. FIG. 10 illustrates a block diagram of an example comprising a machine 1000 upon which any one or more of the techniques (e.g., methodologies) discussed herein may be performed. In various examples, the machine 1000 may operate as a standalone device or may be connected (e.g., networked) to other machines.

In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be a personal computer (PC), a tablet device, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware comprising the circuitry may include variably connected physical components (e.g., execution units, transistors, simple circuits, etc.) including a computer-readable medium physically modified (e.g., magnetically, electrically, such as via a change in physical state or transformation of another physical characteristic, etc.) to encode instructions of the specific operation. In connecting the physical components, the underlying electrical properties of a hardware constituent may be changed, for example, from an insulating characteristic to a conductive characteristic or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine 1000 (e.g., computer system) may include a hardware-based processor 1001 (e.g., a central processing unit (CPU), a graphics processing unit (GPU), a hardware processor core, or any combination thereof), a main memory 1003 and a static memory 1005, some or all of which may communicate with each other via an interlink 1030 (e.g., a bus). The machine 1000 may further include a display device 1009, an input device 1011 (e.g., an alphanumeric keyboard), and a user interface (UI) navigation device 1013 (e.g., a mouse). In an example, the display device 1009, the input device 1011, and the UI navigation device 1013 may comprise at least portions of a touch screen display. The machine 1000 may additionally include a storage device 1020 (e.g., a drive unit), a signal generation device 1017 (e.g., a speaker), a network interface device 1050, and one or more sensors 1015, such as a global positioning system (GPS) sensor, compass, accelerometer, or other sensor. The machine 1000 may include an output controller 1019, such as a serial controller or interface (e.g., a universal serial bus (USB)), a parallel controller or interface, or other wired or wireless (e.g., infrared (IR) controllers or interfaces, near field communication (NFC), etc., coupled to communicate or control one or more peripheral devices (e.g., a printer, a card reader, etc.).

The storage device 1020 may include a machine readable medium on which is stored one or more sets of data structures or instructions 1024 (e.g., software or firmware) embodying or utilized by any one or more of the techniques or functions described herein. The instructions 1024 may also reside, completely or at least partially, within a main memory 1003, within a static memory 1005, within a mass storage device 1007, or within the hardware-based processor 1001 during execution thereof by the machine 1000. In an example, one or any combination of the hardware-based processor 1001, the main memory 1003, the static memory 1005, or the storage device 1020 may constitute machine readable media.

While the machine readable medium is considered as a single medium, the term “machine readable medium” may include a single medium or multiple media (e.g., a centralized or distributed database, and/or associated caches and servers) configured to store the one or more instructions 1024.

The term “machine readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

The instructions 1024 may further be transmitted or received over a communications network 1021 using a transmission medium via the network interface device 1050 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., the Institute of Electrical and Electronics Engineers (IEEE) 802.22 family of standards known as Wi-Fi®, the IEEE 802.26 family of standards known as WiMax®), the IEEE 802.27.4 family of standards, peer-to-peer (P2P) networks, among others. In an example, the network interface device 1050 may include one or more physical jacks (e.g., Ethernet, coaxial, or phone jacks) or one or more antennas to connect to the communications network 1021. In an example, the network interface device 1050 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1000, and includes digital or analog communications signals or other intangible medium to facilitate communication of such software.

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific implementations in which the invention can be practiced. These implementations are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in an aspect are still deemed to fall within the scope of that aspect. Moreover, in the following aspects, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other implementations can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the aspects. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed implementation. Thus, the following aspects are hereby incorporated into the Detailed Description as examples or implementations, with each aspect standing on its own as a separate implementation, and it is contemplated that such implementations can be combined with each other in various combinations or permutations.

What is claimed is:

1. A method for inspecting a substrate, the method comprising:
scanning the substrate across a plurality of scan positions using an interrogation beam having a width substantially equal to or greater than a diameter of at least one surface feature on a surface of the substrate to generate scanning results;
generating a set of raw centroid calculation results based on the scanning results;
determining an error property in the raw centroid calculation results;
removing the error property from the raw centroid calculation results to generate refined centroid calculation results; and
determining a characteristic of the at least one surface feature based on the refined centroid calculation results.

2. The method of claim 1, wherein determining the characteristic of the at least one surface feature comprises:
determining a height of the at least one surface feature performing a laser triangulation technique based on the refined centroid calculation results.

3. The method of claim 2, wherein performing the laser triangulation technique uses a first position of a light source to generate the interrogation beam, a second position of a detector to receive reflections from the interrogation beam, and a third position based on the refined centroid calculation results.

4. The method of claim 1, wherein determining the error property comprises:
plotting the raw centroid calculations against the plurality of scan positions to generate a centroid plot; and
applying a best fit line algorithm to generate a fitted line on the centroid plot, wherein fitted line corresponds to the error property.

5. The method of claim 4, wherein determining the characteristic of the at least one surface feature comprises:
determining a tilt angle of the at least one surface feature.

6. The method of claim 5, wherein the tilt angle is related to a slope of the fitted line.

7. The method of claim 1, wherein the at least one surface feature comprises a soldering bump on the surface of the substrate.

8. An inspection system comprising:
a light source to scan a substrate across a plurality of scan positions using an interrogation beam having a width substantially equal to or greater than a diameter of at least one surface feature on a surface of the substrate to generate scanning results; and
at least one processor to:
generate a set of raw centroid calculation results based on the scanning results;
determine an error property in the raw centroid calculation results;
remove the error property from the raw centroid calculation results to generate refined centroid calculation results; and
determine a characteristic of the at least one surface feature based on the refined centroid calculation results.

9. The inspection system of claim 8, wherein to determine the characteristic of the at least one surface feature comprises:
determine a height of the at least one surface feature performing a laser triangulation technique based on the refined centroid calculation results.

10. The inspection system of claim 9, wherein the laser triangulation technique uses a first position of the light source to generate the interrogation beam, a second position of a detector to receive reflections from the interrogation beam, and a third position based on the refined centroid calculation results.

11. The inspection system of claim 8, wherein to determine the error property comprises:
plot the raw centroid calculations against the plurality of scan positions to generate a centroid plot; and
apply a best fit line algorithm to generate a fitted line on the centroid plot, wherein fitted line corresponds to the error property.

12. The inspection system of claim 11, wherein to determine the characteristic of the at least one surface feature comprises:
determine a tilt angle of the at least one surface feature.

13. The inspection system of claim 12, wherein the tilt angle is related to a slope of the fitted line.

14. The inspection system of claim 8, wherein the at least one surface feature comprises a soldering bump on the surface of the substrate.

15. A machine-storage medium embodying instructions that, when executed by a machine, cause the machine to perform operations comprising:
scanning a substrate across a plurality of scan positions using an interrogation beam having a width substantially equal to or greater than a diameter of at least one surface feature on a surface of the substrate to generate scanning results;
generating a set of raw centroid calculation results based on the scanning results;
determining an error property in the raw centroid calculation results;
removing the error property from the raw centroid calculation results to generate refined centroid calculation results; and
determining a characteristic of the at least one surface feature based on the refined centroid calculation results.

16. The machine-storage medium of claim 15, wherein determining the characteristic of the at least one surface feature comprises:
determining a height of the at least one surface feature performing a laser triangulation technique based on the refined centroid calculation results.

17. The machine-storage medium of claim 16, wherein performing the laser triangulation technique uses a first position of a light source to generate the interrogation beam, a second position of a detector to receive reflections from the interrogation beam, and a third position based on the refined centroid calculation results.

18. The machine-storage medium of claim 15, wherein determining the error property comprises:
plotting the raw centroid calculations against the plurality of scan positions to generate a centroid plot; and
applying a best fit line algorithm to generate a fitted line on the centroid plot, wherein fitted line corresponds to the error property.

19. The machine-storage medium of claim 18, wherein determining the characteristic of the at least one surface feature comprises:
determining a tilt angle of the at least one surface feature.

20. The machine-storage medium of claim 19, wherein the tilt angle is related to a slope of the fitted line.
